(19) United States
(12) Patent Application Publication
(10) Pub. No.: US 2026/0229503 A1
(43) Pub. Date: Aug. 6, 2026

(54) CATHODE FOR LITHIUM SECONDARY BATTERY AND SECONDARY BATTERY COMPRISING SAME

(71) Applicant: SK ON CO., LTD., Seoul (KR)

(72) Inventors: Young Uk PARK, Daejeon (KR); Seung Hyun KIM, Daejeon (KR); Yong Hyun CHO, Daejeon (KR)

(21) Appl. No.: 19/127,741

(22) PCT Filed: Oct. 31, 2023
(86) PCT No.: PCT/KR2023/017112

§ 371 Date: May 7, 2025

(30) Foreign Application Priority Data
Nov. 8, 2022 (KR) 10-2022-0147561

(51) Int. Cl. H01M 4/505; H01M 4/02; H01M 4/525; H01M 10/052

(52) U.S. Cl. CPC H01M 4/505; H01M 4/525; H01M 10/052; H01M 2004/021; H01M 2004/028

(57) ABSTRACT

A cathode for a lithium secondary battery includes: a cathode current collector; and a cathode active material layer formed on the cathode current collector and including over-lithiated oxide particles containing nickel and manganese, wherein a molar ratio of lithium to total metal elements is greater than 1. A manganese content in a surface portion of the over-lithiated oxide particles is greater than a manganese content at a central portion thereof. A nickel content in the central portion of the over-lithiated oxide particles is greater than a nickel content in the surface portion thereof.

This application is a national stage application of PCT/KR2023/017112 filed on Oct. 31, 2023, which claims priority to Korean Patent Application No. 10-2022-0147561 filed on Nov. 8, 2022. The disclosure of each of the foregoing applications is incorporated herein by reference in its entirety.

### TECHNICAL FIELD

The present disclosure relates to a cathode for a lithium secondary battery and a secondary battery including the same, and more specifically, to a cathode for a lithium secondary battery, which exhibits a non-uniform concentration distribution (i.e., concentration gradient), and a lithium secondary battery including the cathod

### BACKGROUND ART

Secondary batteries are batteries that can be repeatedly charged and discharged, and are widely used as a power source for portable electronic devices such as mobile phones and laptop PCs.

A lithium secondary battery has a high operating voltage and a high energy density per unit weight, making it advantageous in terms of charging speed and lightweight design. In this regard, the lithium secondary battery has been actively developed and applied to various industrial fields.

The lithium secondary battery may store an electric energy by a difference in chemical potential when lithium ions are intercalated and deintercalated between a cathode and an anode. Accordingly, the lithium secondary battery may use materials capable of reversibly intercalating and deintercalating the lithium ions as a cathode active material and an anode active material.

For example, as the cathode active material, lithium metal oxide particles having a layered crystal structure of ABO₂ (e.g., lithium cobalt oxide (LiCoO₂), lithium nickel oxide (LiNiO₂), lithium manganese oxide (LiMnO₂), lithium nickel-cobalt-manganese oxide (NCM), lithium nickel-aluminum-manganese oxide (NCA), etc.) are used.

Meanwhile, as the lithium secondary battery is applied to electric vehicles (EVs), lithium metal oxide particles having a higher capacity than the lithium metal oxide particles are being researched and developed. For example, Korean Patent Publication No. 10-1369951 discloses the use of over-lithiated oxide (OLO) particles to improve the capacity of lithium secondary battery.

However, as the content of lithium in the active material increases, the amount of lithium impurities remaining on the surface of the active material may increase, and the cathode density may decrease. In addition, when a high voltage is applied to drive the over-lithiated oxide, the cycle stability upon repeated charging and discharging and high-temperature stability may deteriorate.

### SUMMARY OF INVENTION

### Problems to be Solved by Invention

An object of the present disclosure is to provide a cathode for a lithium secondary battery with high capacity and improved operating stability.

Another object of the present disclosure is to provide a lithium secondary battery with high capacity and improved stability.

### Means for Solving Problems

A cathode for a lithium secondary battery includes: a cathode current collector; and a cathode active material layer formed on the cathode current collector and including over-lithiated oxide particles containing nickel and manganese, wherein a molar ratio of lithium to total metal elements is greater than 1. A manganese content in a surface portion of the over-lithiated oxide particles is greater than a manganese content at a central portion thereof. A nickel content in the central portion of the over-lithiated oxide particles is greater than a nickel content in the surface portion thereof.

In some embodiments, a ratio of the manganese content in the surface portion to the manganese content in the central portion may be in a range of 105% to 200%.

In some embodiments, the ratio of the manganese content in the surface portion to the manganese content in the central portion may be in a range of 105% to 150%.

In some embodiments, a ratio of the nickel content in the surface portion to the nickel content in the central portion may be in a range of 50% to 95%.

In some embodiments, the ratio of the nickel content in the surface portion to the nickel content in the central portion may be in a range of 60% to 95%.

In some embodiments, the central portion and the surface portion of the over-lithiated oxide particles may have different lithium contents.

In some embodiments, the central portion may have a relatively lower lithium content and the surface portion may have a relatively higher lithium content.

In some embodiments, the over-lithiated oxide particles may exhibit a concentration gradient between the central portion and the surface portion.

In some embodiments, the over-lithiated oxide particles may have a chemical structure represented by Formula 1 below:

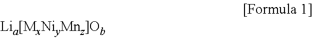

In Formula 1, M includes at least one of Co, Na, Ca, Y, Hf, Ta, B, Si, Ba, Ra, Mg, V, Ti, Al, Fe, Ru, Zr, W, Sn, Nb, Mo, Cu, Zn, Cr, Ga and Bi, and x, y, z, a and b satisfy 0≤x≤0.9, 0<y≤0.9, 0.1≤z≤0.9, 1.8≤a+x+y+z≤2.2, 1.05≤a/(x+y+z)≤1.95, 1.8≤b≤2.2.

In some embodiments, a mole fraction of manganese to the total elements excluding lithium and oxygen in the over-lithiated oxide particles may be 0.5 to 0.75.

In some embodiments, the central portion may be a region extending radially outward from the center of the over-lithiated oxide particle within a range of 0.5 μm, and the surface portion may be a region extending inward from the outermost surface of the over-lithiated oxide particle toward the center within a depth or thickness of 0.5 μm.

In some embodiments, the contents of manganese and nickel may be determined based on integrated peak intensity values of manganese and nickel obtained by a line-scan EDS analysis performed along a straight line passing through the center on the cross-section of the over-lithiated oxide particle exposed to the cross-section of the cathode active material layer, from one end to the other end of the particle.

In some embodiments, the over-lithiated oxide particles may include at least one of a Li₂MnO₃ domain and a domain derived from the Li₂MnO₃ domain.

In some embodiments, the domain derived from the Li₂MnO₃ domain may include at least one selected from the group consisting of MnO₂, Mn₂O₄, LiMnO₂, LiMn₂O₄ and Li₂Mn₂O₄.

A lithium secondary battery includes: the cathode for a lithium secondary battery according to the above-described embodiments; and an anode disposed opposite to the cathode.

### Advantageous Effects

The cathode for a lithium secondary battery according to embodiments of the present disclosure may include a lithium metal oxide including an over-lithiated oxide in a surface portion and having a relatively higher manganese content in the surface portion. The operating voltage of the lithium secondary battery may be increased by the lithium-rich composition, and the thermal stability of the lithium secondary battery may be improved by the increased manganese composition in the surface portion.

In some embodiments, the lithium metal oxide may have a relatively lower nickel content in the surface portion. Accordingly, high-capacity characteristics may be implemented by the high-Ni composition in the central portion while further enhancing the operational stability in the surface portion.

By designing the concentrations of the above-described transition metal elements, a high-voltage and high-capacity secondary battery may be implemented while also improving high-temperature stability and cycle life characteristics.

### BRIEF DESCRIPTION OF DRAWINGS

FIG. 1 is a schematic cross-sectional view illustrating a cathode for a lithium secondary battery according to exemplary embodiments.

FIG. 2 is a graph showing the concentration distribution of the cathode active material according to exemplary embodiments.

FIGS. 3 and 4 are schematic plan and cross-sectional views illustrating a lithium secondary battery according to exemplary embodiments, respectively.

FIGS. 5 and 6 are scanning electron microscopy (SEM) cross-sectional images of cathode active material layers including cathode active materials prepared according to Examples 1 and 2, respectively.

FIGS. 7 to 10 are scanning electron microscopy (SEM) cross-sectional images of cathode active material layers including cathode active materials prepared according to the comparative examples.

### Mode for Carrying Out Invention

According to exemplary embodiments of the present disclosure, a cathode for a lithium secondary battery, which includes a cathode active material having an increased lithium content and a variation in metal concentration, is provided. In addition, a lithium secondary battery including the cathode is also provided.

Hereinafter, a cathode for a lithium secondary battery and a lithium secondary battery including the same according to exemplary embodiments of the present disclosure will be described in more detail with reference to the drawings. However, the drawings and the embodiments are merely an example, and the present disclosure is not limited to the drawings and the embodiments described as examples.

### <Cathode for Lithium Secondary Battery>

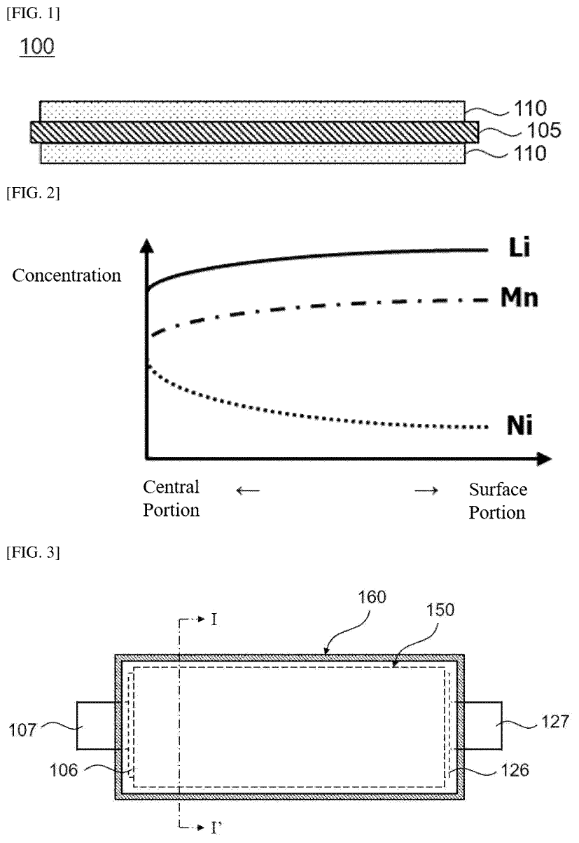

FIG. 1 is a schematic cross-sectional view illustrating a cathode for a lithium secondary battery according to exemplary embodiments.

Referring to FIG. 1, a cathode 100 for a lithium secondary battery may include a cathode current collector 105 and a cathode active material layer 110 formed on the cathode current collector 105.

For example, the cathode active material layer 110 may be formed on one surface or both surfaces of the cathode current collector 105.

For example, the cathode current collector 105 may include stainless steel, nickel, aluminum, titanium, copper, or an alloy thereof, and preferably includes aluminum or an aluminum alloy.

The cathode active material layer 110 may include cathode active material capable of reversibly intercalating and deintercalating lithium ions. For example, the cathode active material may include lithium metal oxide particles.

The cathode active material may include lithium metal oxide particles. According to exemplary embodiments, the lithium metal oxide particles may be present in the form of over-lithiated oxide particles.

According to exemplary embodiments, the over-lithiated oxide particles may contain nickel and manganese, wherein a molar ratio of lithium to total metal elements included in the over-lithiated oxide particles may be greater than 1.

The cathode active material may include a plurality of over-lithiated oxide particles. In some embodiments, a content of the over-lithiated oxide particles may be 50% by weight (“wt %”) or more based on the total weight of the cathode active material, and preferably 60 wt % or more, 70 wt % or more, 80 wt % or more, or 90 wt % or more.

In one embodiment, the cathode active material may consist substantially of the over-lithiated oxide particles.

In one embodiment, the over-lithiated oxide particle may include a Li₂MnO₃ domain (C2/m space group) and a LiₐM_{b}O_{c} domain (R3m space group, wherein M is at least one of Co, Na, Ca, Y, Hf, Ta, B, Si, Ba, Ra, Mg, V, Ti, Al, Fe, Ru, Zr, W, Sn, Nb, Mo, Cu, Zn, Cr, Ga and Bi, and a, b and c satisfy 1.8≤a+b≤2.2, 0.9≤a/b<1.05, and 1.9≤c≤2.1).

In some embodiments, in the over-lithiated oxide particles, the molar ratio of the Li₂MnO₃ domain and the LiMO₂ domain may be represented as w:1-w, wherein w may be 0.05 to 0.7, or 0.1 to 0.7.

For example, the over-lithiated oxide particles may be prepared by a co-precipitation method.

For example, metal salts, a chelating agent (e.g., aqueous ammonia, ammonium carbonate, etc.), and a co-precipitating agent (e.g., sodium hydroxide, sodium carbonate, etc.) may be mixed and subjected to a co-precipitation reaction to prepare metal hydroxide particles. For example, the molar ratio among the metal salts may be adjusted according to the chemical formula of the intended over-lithiated oxide particles.

For example, the metal hydroxide particles and the lithium source may be mixed and calcined so that the molar ratio of the number of moles of the lithium source to the number of moles of the metal hydroxide particles is in a range of 1.05 to 1.95, 1.1 to 1.95, 1.15 to 1.95, or 1.2 to 1.95, thereby preparing the over-lithiated oxide particles.

In one embodiment, the lithium source may include lithium hydroxide or lithium carbonate. In some embodiments, the lithium source may include lithium hydroxide.

According to exemplary embodiments, the metal hydroxide particles as a nickel-manganese precursor and lithium hydroxide as a lithium precursor may be mixed to form a precursor mixture. A first heat treatment and a second heat treatment may then be performed on the precursor mixture to form over-lithiated oxide particles.

In some embodiments, the first heat treatment may be performed at a temperature in a range of 200 to 300° C. The second heat treatment may be performed at a temperature in a range of 800 to 900° C.

As described above, the first heat treatment may be performed at a relatively low temperature to selectively induce lithium intercalation into the surface portion of particles. Accordingly, the concentration of lithium at the surface portion may be increased. Thereafter, the second heat treatment may be performed at a high temperature to stabilize the resulting concentration gradient, thereby obtaining over-lithiated oxide particles.

For example, the over-lithiated oxide particles may be activated by applying a voltage of 4.4 V (vs Li/Li⁺) or higher (e.g., 4.4 V to 4.8 V) to the over-lithiated oxide particles (see Scheme 1-1 below). Alternatively, the over-lithiated oxide particles may be activated by charging and discharging a lithium secondary battery including the over-lithiated oxide particles at a voltage of 4.4 V (vs Li/Li⁺) or higher (see Schemes 1-1 and 1-2 below).

In one embodiment, the activated particles may include a domain derived from a Li₂MnO₃ domain in the over-lithiated oxide particles.

In some embodiments, the domain derived from the Li₂MnO₃ domain may include at least one of MnO₂, Mn₂O₄, LiMnO₂, LiMn₂O₄ and Li₂Mn₂O₄.

For example, at least some of the Li₂MnO₃ in the over-lithiated oxide particles may be converted into MnO₂ and LiMnO₂ by activation, as shown in Schemes 1-1 and 1-2 below. The MnO₂ and LiMnO₂ may reversibly intercalate and deintercalate lithium ions as shown in Scheme 2 below. Accordingly, the over-lithiated oxide particles may provide an increased capacity.

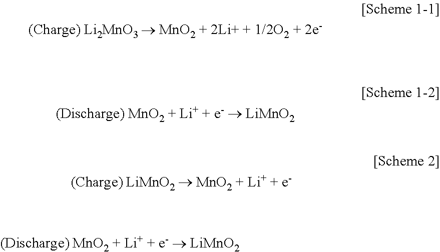

In some embodiments, the LiMnO₂ in the activated particles may further react and be converted into Mn₂O₄, LiMn₂O₄ or Li₂Mn₂O₄.

In some embodiments, the activated particles may include the LiₐM_{b}O_{c} domains, and Li₂MnO₃ domains and/or domains derived from the Li₂MnO₃ domains.

In exemplary embodiments, the over-lithiated oxide particles and/or the activated particles may be represented by Formula 1 below.

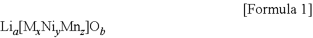

In Formula 1, M may include at least one of Co, Na, Ca, Y, Hf, Ta, B, Si, Ba, Ra, Mg, V, Ti, Al, Fe, Ru, Zr, W, Sn, Nb, Mo, Cu, Zn, Cr, Ga and Bi.

Wherein, x, y, z, a and b may satisfy 0≤x≤0.9, 0<y≤0.9, 0.1≤z≤0.9, 1.8≤a+x+y+z≤2.2, 1.05≤a/(x+y+z)≤1.95, 1.8≤b≤2.2.

In some embodiments, x may be in a range of 0<x≤0.9, 0.05≤x≤0.9, 0.1≤x≤0.9, 0<x≤0.8, 0.05≤x≤0.8, or 0.1≤x≤0.8.

In some embodiments, y may be in a range of 0<y≤0.9, 0.05≤y≤0.9, 0.1≤y≤0.9, 0<y≤0.8, 0.05≤y≤0.8, or 0.1≤y≤0.8

In some embodiments, x, y and z may satisfy 1.1≤a/(x+y+z)≤1.95, 1.15≤a/(x+y+z)≤1.95, 1.2≤a/(x+y+z)≤1.95, or 1.3≤a/(x+y+z)≤1.95.

In some embodiments, a mole fraction of manganese relative to the total elements excluding lithium and oxygen in the over-lithiated oxide particles may be 0.5 to 0.75. For example, x, y and z may satisfy 0.5≤z/(x+y+z)≤0.75.

In some embodiments, x, y and z may satisfy 0.25≤(x+y)/(x+y+z)≤0.5.

In some embodiments, the mole fraction of cobalt relative to the total elements excluding lithium and oxygen in the over-lithiated oxide particles may be 0 to 0.02. In one embodiment, the over-lithiated oxide particles may not contain cobalt.

In some embodiments, b may be in a range of 1.9≤b≤2.1, or 1.95≤b≤2.05.

According to embodiments of the present disclosure, the central portion and the surface portion of the over-lithiated oxide particle may have different manganese contents. The central portion may have a relatively lower manganese content, while the surface portion may have a relatively higher manganese content.

According to embodiments of the present disclosure, a ratio of the manganese content in the surface portion to the manganese content in the central portion, expressed as a percentage, may be in a range of 105% to 200%.

The term “content” as used herein may refer to the concentration or molar ratio of the metal element to the total metal elements in the chemical structure of the lithium metal oxide particle or the over-lithiated oxide particle.

In some embodiments, the ratio of the manganese content in the surface portion to the manganese content in the central portion, expressed as a percentage, may be in a range of 105% to 150%. Preferably, the manganese content ratio may be in a range of 105% to 140%, 107% to 140%, 107% to 138%, or 107% to 136%. Within the above range, the high-temperature stability may be effectively enhanced without degrading the rate characteristics of the lithium secondary battery.

As described above, by increasing the manganese content in the surface portion, the chemical stability of the cathode active material in the surface portion may be enhanced.

For example, the Li₂MnO₃ domain may be easily concentrated in the surface portion due to the increased manganese content in the surface portion. Accordingly, the activation of the Li₂MnO₃ domain may be rapidly performed in the surface portion. Therefore, the activation that causes instability in the cathode active material may be preferentially and promptly completed, thereby enhancing the chemical stability and cycle life characteristics of the cathode active material.

In addition, the localized concentration of the thermally stable Li₂MnO₃ domain in the surface portion may be increased, thereby enhancing the thermal stability of the cathode and the secondary battery.

The central portion may refer to a region extending outward from the center of the lithium metal oxide particle or the over-lithiated oxide particle to a predetermined radial distance. The surface portion may refer to a region extending inward from the outermost surface of the lithium metal oxide particle or the over-lithiated oxide particle toward the center to a predetermined depth or thickness.

For example, the central portion may be a region extending radially outward from the center within a range of 0.5 μm. The surface portion may be a region extending inward from the outermost surface toward the center within a depth or thickness of 0.5 μm.

In some embodiments, the central portion and the surface portion of the over-lithiated oxide particle may have different nickel contents. The central portion may have a relatively higher nickel content, while the surface portion may have a relatively lower nickel content.

According to embodiments of the present disclosure, the ratio of the nickel content in the surface portion to the nickel content in the central portion may be in a range of 50% to 95%.

In some embodiments, the ratio of nickel content in the surface portion to nickel content in the central portion, expressed as a percentage, may be in a range of 60% to 95%. Preferably, the nickel content ratio may be in a range of 60% to 90%, 60% to 89%, or 60% to 88%.

As described above, by increasing the nickel content in the central portion, the chemical stability of the cathode active material may be enhanced in the surface portion. Accordingly, capacity enhancement through nickel may be achieved in the central portion, and the increased manganese content in the surface portion may facilitate early activation, thereby contributing to particle stabilization and thermal stability.

In one embodiment, the central portion and the surface portion of the over-lithiated oxide particle may have different lithium contents. The central portion may have a relatively lower lithium content, and the surface portion may have a relatively higher lithium content.

By increasing the content of lithium in the surface portion, the activation of the Li₂MnO₃ domain at the surface portion may be further facilitated in combination with the increased manganese content in the surface portion. Accordingly, the activation rate may be increased, thereby promoting early stabilization of the cathode active material more effectively.

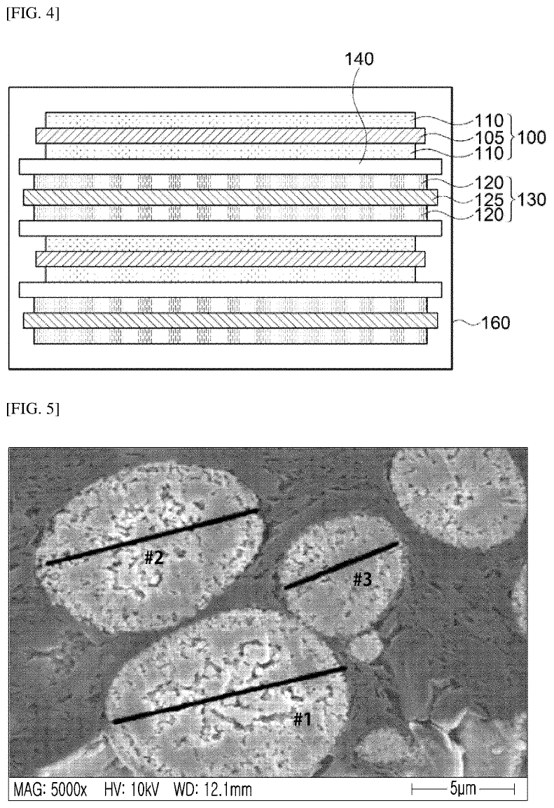

FIG. 2 is a graph showing the concentration distribution of the cathode active material according to exemplary embodiments.

Referring to FIG. 2, the metal elements of the lithium metal oxide particles or the over-lithiated oxide particles may exhibit a concentration gradient.

In some embodiments, lithium may exhibit a concentration gradient that increases from the central portion of the particle toward the surface portion. Manganese may exhibit a concentration gradient that increases from the central portion of the particle toward the surface portion. Nickel may exhibit a concentration gradient that decreases from the central portion of the particle toward the surface portion.

As shown in FIG. 2, the concentration of lithium among nickel, manganese and lithium may be the highest throughout both the central portion and the surface portion, and the concentration of manganese may be higher than the concentration of nickel. In some embodiments, the concentration difference between manganese and nickel in the central portion may be lower than the concentration difference between manganese and nickel in the surface portion. In some embodiments, the concentration difference between lithium and manganese in the surface portion may be lower than the concentration difference between manganese and nickel in the surface portion.

FIG. 2 schematically illustrates the concentration gradient for convenience of description, and the concentration changes or concentration gradient profiles of the metal elements are not necessarily limited to those shown in FIG. 2.

In some embodiments, the lithium metal oxide particle or the over-lithiated oxide particle may have a secondary particle form. The over-lithiated oxide particle may have a form in which a plurality of primary particles are aggregated with each other. For example, 30, 40, 50, 80, or 100 or more primary particles may be aggregated with each other in one over-lithiated oxide particle.

In some embodiments, the over-lithiated oxide particle (the secondary particle) may have a median particle diameter D50 of 2 μm to 9 μm. The median particle diameter D50 may refer to a particle diameter at the 50% point of the volume particle size distribution, and may be measured using a laser diffraction method.

In some embodiments, the over-lithiated oxide particle may have a specific surface area (BET) of 2.1 m²/g or more. Preferably, the over-lithiated oxide particles have a specific surface area (BET) of 2.2 m²/g or more, 2.4 m²/g or more, or 2.5 m²/g or more. More preferably, the over-lithiated oxide particles have a specific surface area (BET) of 2.6 m²/g or more, for example, 3.0 m²/g or less.

Within the above specific surface area range, the initial activation of the over-lithiated oxide particles may be facilitated, thereby further promoting the formation of stable Li₂MnO₃ domains on the surface portion.

In some embodiments, M in Formula 1 may be included as a dopant in the over-lithiated oxide particles. For example, at least one element of Co, Na, Ca, Y, Hf, Ta, B, Si, Ba, Ra, Mg, V, Ti, Al, Fe, Ru, Zr, W, Sn, Nb, Mo, Cu, Zn, Cr, Ga and Bi may be included as a dopant in the chemical or crystal structure of the over-lithiated oxide particles having a chemical structure of Li—Ni—Mn—O according to Formula 1.

In some embodiments, a coating may be formed on the over-lithiated oxide particles. The coating may contain B, Al, W, Zr, Ti, Mg and/or Co as a coating element.

The concentration or gradient of the metal element within the lithium metal oxide particles or the over-lithiated oxide particles described above may be analyzed by energy-dispersive X-ray spectroscopy (EDS). For example, the concentration or gradient of the metal element may be measured or calculated by a line-scan EDS analysis.

For example, the line-scan EDS analysis may be performed along a straight line passing through the center of the particle on the cross-section of the particle, from one end to the other end of the particle.

The content of the metal element in the surface portion of the particle may be measured based on the integrated peak intensity values of the metal elements in the surface portion of the particles. The content of the metal element in the central portion of the particle may be measured based on the integrated peak value of the metal element at the central portion of the particle.

For example, the contents of manganese and nickel may be measured by a line-scan EDS analysis using the cross-section of the lithium metal oxide particles or the over-lithiated oxide particles exposed to the cross-section of the cathode active material layer 110.

In one embodiment, when the manganese content is measured by a line-scan EDS analysis by randomly selecting three lithium metal oxide particles exposed to the cross-section of the cathode active material layer 110, at least one of the particles may satisfy the above-described manganese content ratio.

In one embodiment, when the manganese content is measured by a line-scan EDS analysis by randomly selecting three lithium metal oxide particles exposed to the cross-section of the cathode active material layer 110, two or three of the particles may satisfy the above-described manganese content ratio.

The cathode active material layer 110 may further include a binder and a conductive material.

In one embodiment, the binder may include an organic binder such as polyvinylidene fluoride (PVDF), vinylidene fluoride-hexafluoropropylene copolymer, polyacrylonitrile, or polymethyl methacrylate, etc.; or an aqueous binder such as styrene-butadiene rubber (SBR). In some embodiments, the binder may be used together with a thickener such as carboxymethyl cellulose (CMC).

The conductive material may include carbon-based conductive materials such as graphite, carbon nanotubes (CNTs), carbon black, and graphene, etc.; metal-based conductive materials, including perovskite materials, such as tin, tin oxide, titanium oxide, LaSrCoO₃, and LaSrMnO₃, etc.

In one embodiment, an active material loading of the cathode active material layer 110 may be 5 to 28 mg/cm², 7 to 25 mg/cm², 8 to 20 mg/cm², or 9 to 15 mg/cm².

In one embodiment, a density of the cathode active material layer 110 may be 2.5 to 3.8 g/cc, 2.6 to 3.7 g/cc, or 2.7 to 3.6 g/cc.

### <Lithium Secondary Battery>

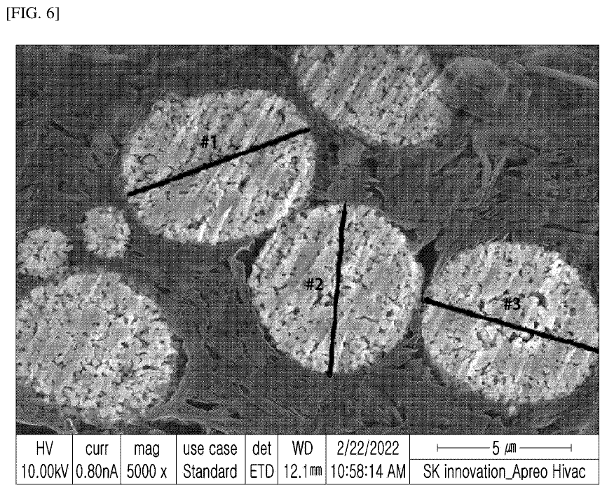

FIGS. 3 and 4 are schematic plan and cross-sectional views illustrating a lithium secondary battery according to exemplary embodiments, respectively. FIG. 4 is a cross-sectional view taken on line I-I′ of FIG. 3 in a thickness direction of the battery.

In FIG. 4, for convenience of description, a separation membrane 140 is illustrated as being separated and spaced apart in the thickness direction, but the separation membrane 140 may be continuously extended and wound.

Referring to FIGS. 3 and 4, the lithium secondary battery may include an electrode assembly 150 and a case 160 that houses the electrode assembly 150.

The electrode assembly 150 may include the cathode 100 and an anode 130 disposed opposite to the cathode 100.

In one embodiment, the electrode assembly 150 may include a plurality of cathodes and a plurality of anodes which are alternately and repeatedly disposed.

In one embodiment, the electrode assembly 150 may further include the separation membrane 140 interposed between the cathode 100 and the anode 130.

The lithium secondary battery may include the above-described cathode 100 according to the embodiments of the present disclosure. As described above, the cathode 100 may include the cathode current collector 105 and the cathode active material layer 110. For example, the cathode active material layer 110 may be formed on one surface or both surfaces (upper and lower surfaces) of the cathode current collector 105.

The cathode active material layer 110 may include the above-described cathode active material according to the embodiments of the present disclosure. The cathode active material includes the above-described lithium metal oxide particles, and the lithium metal oxide particles may include over-lithiated oxide particles.

When the over-lithiated oxide particles are used as the cathode active material, voltage decay may occur during the operation of the lithium secondary battery. As described above, by changing the concentration of manganese, the activation of the cathode active material at the surface portion may be quickly completed, thereby promoting the stabilization of the cathode active material at an early stage of the operation of the lithium secondary battery.

Therefore, a lithium secondary battery having improved high-temperature stability and cycle life stability may be achieved even during high-voltage charge and discharge operation.

The anode 130 may include an anode current collector 125 and an anode active material layer 120. For example, the anode active material layer 120 may be formed on one surface or both surfaces of the anode current collector 125.

For example, the anode active material layer 120 may include an anode active material, the binder, and the conductive material.

For example, the anode current collector 125 may include gold, stainless steel, nickel, aluminum, titanium, copper, or an alloy thereof, and preferably includes copper or a copper alloy.

In one embodiment, the anode active material may include a material capable of intercalating and deintercalating lithium ions. For example, the anode active material may include a lithium alloy, a carbon-based active material, a silicon-based active material, etc.

For example, the lithium alloy may further include aluminum, zinc, bismuth, cadmium, antimony, silicon, lead, tin, gallium, indium and the like.

For example, the carbon-based active material may include crystalline carbon, amorphous carbon, carbon composite, carbon fiber and the like.

For example, the amorphous carbon may include hard carbon, cokes, mesocarbon microbeads, mesophase pitch-based carbon fiber and the like.

For example, the crystalline carbon may include natural graphite, artificial graphite, graphite cokes, graphite MCMB, graphite MPCF and the like.

For example, the silicon-based active material may include Si, SiOₓ (0<x<2), Si/C, SiO/C, Si-Metal and the like.

In some embodiments, the anode 130 may have an area greater than that of the cathode 100.

In one embodiment, the cathode current collector 105 may include a cathode tab 106 protruding from one side of the cathode current collector 105.

For example, the cathode tab 106 may be formed integrally with the cathode current collector 105 or may be connected with the cathode current collector 105 by welding, etc. The cathode current collector 105 and the cathode lead 107 may be electrically connected with each other through the cathode tab 106.

In one embodiment, the anode current collector 125 may include an anode tab 126 protruding from one side of the anode current collector 125.

For example, the anode tab 126 may be formed integrally with the anode current collector 125, or may be electrically connected with the anode current collector 125 by welding, etc. The anode current collector 125 and the anode lead 127 may be electrically connected with each other through the anode tab 126.

For example, the separation membrane 140 may include a porous polymer film made of a polyolefin polymer such as polyethylene, polypropylene, ethylene-butene copolymer, ethylene-hexene copolymer, or ethylene-methacrylate copolymer. For example, the separation membrane 140 may include a nonwoven fabric made glass fiber having a high melting point, polyethylene terephthalate fiber or the like.

For example, the electrode assembly 150 and the electrolyte may be housed together in the pouch case 160 to form a lithium secondary battery.

In one embodiment, the electrolyte may include a lithium salt and an organic solvent.

In one embodiment, the lithium salt may include Li X. For example, X may be at least one of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

In one embodiment, the organic solvent may include a carbonate solvent such as ethylene carbonate (EC), propylene carbonate (PC), dimethyl carbonate (DMC), diethyl carbonate (DEC), ethyl methyl carbonate (EMC), etc.; an ester solvent such as methyl propionate, ethyl propionate, ethyl acetate, propyl acetate, butyl acetate, butyrolactone, caprolactone, valerolactone, etc.; an ether solvent such as dibutyl ether, tetraethylene glycol dimethyl ether (TEGDME), diethylene glycol dimethyl ether (DEGDME), tetrahydrofuran (THF), etc.; an alcohol solvent such as ethyl alcohol, isopropyl alcohol, etc.; a ketone solvent such as cyclohexanone, etc.; an aprotic solvent such as an amide solvent (e.g., dimethylformamide), a dioxolane solvent (e.g., 1,3-dioxolane), a sulfolane solvent, a nitrile solvent, etc.

In exemplary embodiments, an upper limit of operating voltage of the lithium secondary battery may be 4.5 V or less relative to an oxidation-reduction potential of lithium (i.e., a redox potential) (vs Li/Li⁺). For example, the lithium secondary battery may be operated in a voltage section of 4.5 V (vs Li/Li⁺) or less.

The “upper limit of operating voltage” refers to the upper voltage reached during actual operation of the lithium secondary battery (i.e., during real-world use), and may be distinguished from the activation voltage during an activation process in a manufacturing process of the lithium secondary battery. Accordingly, the voltage decay and energy reduction of the lithium secondary battery may be suppressed.

In one embodiment, a lower limit of operating voltage of the lithium secondary battery may be 1.8 V or more, 1.9 V or more, or 2.0 V or more relative to the oxidation-reduction potential of lithium (vs Li/Li⁺). In some embodiments, the lower limit of operating voltage may be 1.8 V to 2.2 V.

In some embodiments, an operating voltage range (i.e., an operating voltage section) of the lithium secondary battery may be 2 V (vs Li/Li⁺) to 4.5 V (vs Li/Li⁺).

Hereinafter, preferred examples and comparative examples of the present disclosure will be described. However, the following examples are merely exemplary and should not be construed as limiting the scope of the present disclosure.

### Example 1

### (1) Preparation of Over-Lithiated Oxide Particles

Distilled water from which dissolved oxygen had been removed was input into a sealed reactor, and NiSO₄·6H₂O and MnSO₄·H₂O were added at a predetermined molar ratio as nickel and manganese precursors, respectively (a first metal source mixture).

NaOH (precipitant) and NH₄OH (chelating agent) were additionally introduced into the reactor to maintain the pH within the reactor in the range of 10 to 12 and to form an N₂ atmosphere.

While the co-precipitation reaction was performed, a second metal source mixture, in which the molar ratio of the nickel precursor was reduced and the molar ratio of the manganese precursor was increased compared to the initial precursors, was added, and the co-precipitation reaction was continued to prepare metal hydroxide particles having a concentration gradient (Mn-rich in the surface portion, Ni-rich in the central portion). The total duration of the co-precipitation reaction was 60 hours.

The metal hydroxide particles were washed and dehydrated using a filter press. The dehydrated metal hydroxide particles were dried at 120° C. for more than one day, and classified to obtain nickel-manganese precursor powder.

The nickel-manganese precursor powder, the metal hydroxide particles, and lithium hydroxide (as a lithium precursor) were introduced into a calcination furnace to form a precursor mixture, and heat treatment was performed.

Specifically, lithium hydroxide was weighed and mixed so that the molar ratio of lithium to the total metal included in the precursor mixture was 1.2 or more. The calcination furnace was heated to 250° C. at a heating rate of 2° C./min, and the first heat treatment was performed while maintaining the temperature at 250° C. for 3 hours.

Thereafter, the temperature of the calcination furnace was increased to 850° C. at a rate of 2° C./min, and the second heat treatment was performed while maintaining the temperature at 850° C. for 8 hours. Oxygen gas was continuously supplied to the calcination furnace at a flow rate of 10 mL/min during both the first and second heat treatments.

The heat-treated product was naturally cooled to room temperature, then pulverized and classified to prepare over-lithiated oxide particles.

As a result of analyzing the over-lithiated oxide particles by ICP (normalizing the number of oxygen atoms to 2), it was confirmed that particles having a composition of Li_{1.11}Ni_{0.34}Mn_{0.55}O₂ were formed.

### (2) Manufacture of Preliminary Lithium Secondary Battery (Half-Coin Cell)

The over-lithiated oxide particles, carbon black, and PVDF were mixed in a mass ratio of 92:5:3, and then the mixture was dispersed in N-methyl-2-pyrrolidone (NMP) to prepare a cathode slurry.

The cathode slurry was applied to an aluminum foil, then dried and pressed to prepare a cathode having a cathode active material layer formed thereon. When preparing the cathode, the loading amount of the cathode active material layer was adjusted to 11 mg/cm², and the density of the cathode active material layer was adjusted to 2.8 g/cc. Lithium metal was used as the counter electrode (anode).

The cathode and anode were laminated by notching them into circular shapes having a diameter of Φ14 and Φ16, respectively, and a separation membrane (PE, thickness: 13 μm) notched into Φ19 was interposed between the cathode and the anode to form an electrode assembly.

The electrode assembly was placed in a coin cell case (2016 standard), and an electrolyte was injected into the coin cell case to manufacture a preliminary lithium secondary battery.

The electrolyte used herein was prepared by dissolving 1M LiPF₆ solution in a mixed solvent of EC/EMC (30/70, v/v).

### (3) Manufacture of Lithium Secondary Battery (Activation Stage of Preliminary Lithium Secondary Battery)

The preliminary lithium secondary battery was subjected to CC/CV charging (0.1C constant current, CC section CUT-OFF condition: 4.6V, CV section CUT-OFF condition: 0.05C) and CC discharging (0.1C constant current, 2.0V CUT-OFF) at 25° C.

The charging and discharging cycles were repeatedly performed twice to activate the over-lithiated oxide particles.

### Example 2

Over-lithiated oxide particles (Li_{1.11}Ni_{0.34}Mn_{0.55}O₂) and a lithium secondary battery were manufactured in the same manner as in Example 1, except that the timing of introduction of the second metal source mixture was changed to form a steeper concentration gradient.

### Comparative Example 1

Over-lithiated oxide particles and a lithium secondary battery were manufactured in the same manner as in Example 1, except that the molar ratios of nickel precursor, manganese precursor, and lithium precursor were changed so that the composition of over-lithiated oxide particles was Li_{1.15}Ni_{0.30}Mn_{0.55}O₂, and a single metal source mixture was used during the co-precipitation reaction, thereby preventing the formation of a concentration gradient of nickel and manganese.

### Comparative Example 2

Over-lithiated oxide particles and a lithium secondary battery were manufactured in the same manner as in Example 1, except that the molar ratios of the nickel precursor, the manganese precursor, and the lithium precursor were changed so that the composition of the over-lithiated oxide particles was Li_{1.09}Ni_{0.39}Mn_{0.52}O₂, and a single metal source mixture was used during the co-precipitation reaction, thereby preventing the formation of a concentration gradient of nickel and manganese.

### Comparative Example 3

Over-lithiated oxide particles and a lithium secondary battery were manufactured in the same manner as in Example 1, except that the molar ratios of the nickel precursor, the manganese precursor, and the lithium precursor were changed so that the composition of the over-lithiated oxide particles was Li_{1.20}Ni_{0.22}Mn_{0.58}O₂, and a single metal source mixture was used during the co-precipitation reaction, thereby preventing the formation of a concentration gradient of nickel and manganese.

### Comparative Example 4

Over-lithiated oxide particles and a lithium secondary battery were manufactured in the same manner as in Example 1, except that the molar ratios of the nickel precursor, the manganese precursor, and the lithium precursor were changed so that the composition of over-lithiated oxide particles was Li_{1.13}Ni_{0.29}Mn_{0.58}O₂, and a single metal source mixture was used during the co-precipitation reaction, thereby preventing the formation of a concentration gradient of nickel and manganese.

The average particle diameter D50 and the specific surface area (BET) of the over-lithiated oxide particles of the examples and comparative examples were measured and are described together in Table 1 below.

The specific surface area was calculated as the surface area per unit mass by measuring the physical adsorption of gas molecules on the solid surface according to the ISO 9277 standard, using a 3-Flex Adsorption Analyzer system.

TABLE 1

| | Average overall | Molar ratio of | | |
|---|---|---|---|---|
| | composition of the | lithium to total | | |
| | over-lithiated oxide | metal elements | D50 | BET |
| | particles | (Li/Me) | (μm) | (m²/g) |
| Example 1 | Li_{1.11}Ni_{0.34}Mn_{0.55}O₂ | 1.25 | 7.1 | 2.66 |
| Example 2 | Li_{1.11}Ni_{0.34}Mn_{0.55}O₂ | 1.25 | 7.0 | 2.62 |
| Comparative | Li_{1.15}Ni_{0.30}Mn_{0.55}O₂ | 1.35 | 6.6 | 2.46 |
| Example 1 | | | | |
| Comparative | Li_{1.09}Ni_{0.39}Mn_{0.52}O₂ | 1.2 | 3.9 | 1.5 |
| Example 2 | | | | |
| Comparative | Li_{1.20}Ni_{0.22}Mn_{0.58}O₂ | 1.5 | 4.0 | 1.5 |
| Example 3 | | | | |
| Comparative | Li_{1.13}Ni_{0.29}Mn_{0.58}O₂ | 1.3 | 5.9 | 5.0 |
| Example 4 | | | | |

### Experimental Example

### (1) Analysis of Manganese and Nickel Concentrations

Three cathode active material particles were randomly extracted from the SEM cross-sections of the cathode active material layers prepared according to the examples and comparative examples. The contents of manganese and nickel in the central portion and surface portion of each of the three selected particles were measured using line-scan EDS equipment.

Specifically, the contents were measured by line scanning from one end to the other end of each particle along a straight line passing through the center of each particle.

The integrated peak intensity values of nickel and manganese in a region extending radially inward from one end toward the center within a depth of 0.5 μm (a first surface portion) and a region extending radially inward from the other end toward the center within a depth of 0.5 μm (a second surface portion) were measured. The contents of manganese and nickel in the surface portion were obtained by adding the integrated values from the first surface portion and the second surface portion.

Additionally, the contents of manganese and nickel in the central portion were obtained based on the peak intensity integrated values of manganese and nickel from a point located 0.5 μm toward one end to a point located 0.5 μm toward the other end from the center of the particle.

The above-described line-scan EDS analysis conditions are as follows.
i) Equipment name: Apreo 2S (FEI)
ii) Acceleration voltage: 10 kV
iii) FlatQuad Detector, Working Distance 11 to 12 mm

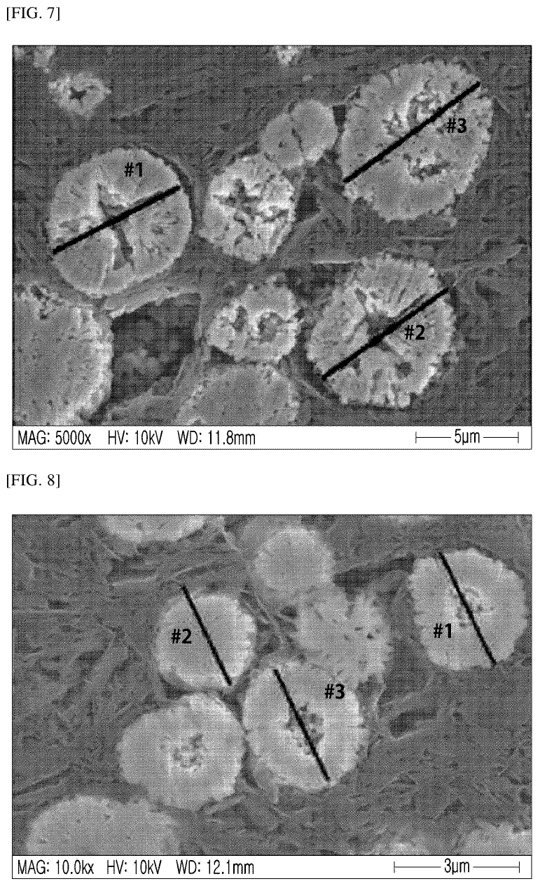

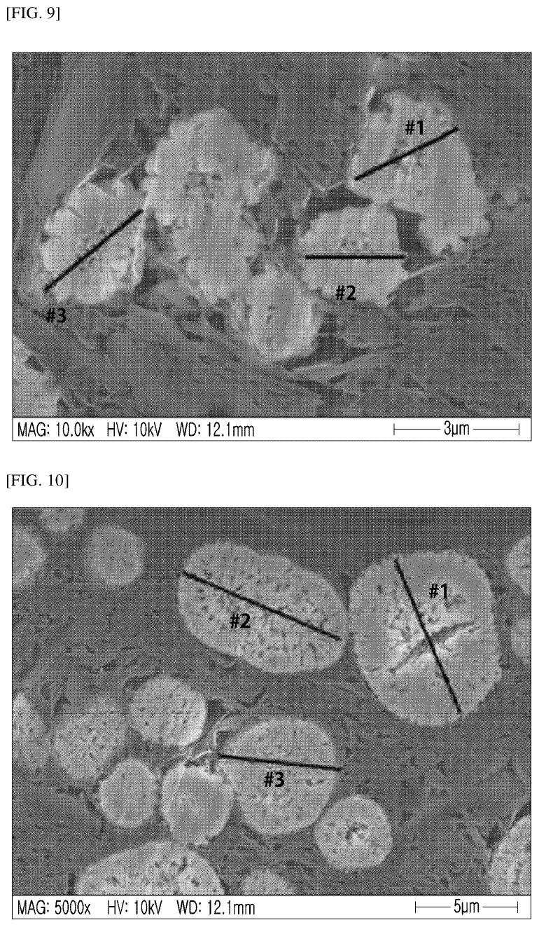

FIGS. 5 and 6 are scanning electron microscopy (SEM) cross-sectional images of cathode active material layers including cathode active materials prepared according to Examples 1 and 2, respectively. FIGS. 7, 8, 9 and 10 are scanning electron microscopy (SEM) cross-sectional images of cathode active material layers including cathode active materials prepared according to Comparative Examples 1, 2, 3 and 4, respectively.

FIGS. 5 to 10 show the numbers of particles on which the above-described Line-scan EDS was performed, along with the line scan directions indicated for each particle.

### (2) Thermal Stability Analysis (DSC Analysis)

Using a Thermal Analysis System DSC 3 (product from METTLER TOLEDO), the over-lithiated oxide particles of the examples and comparative examples were analyzed by differential scanning calorimetry (DSC) to measure the onset temperature at which the exothermic peak appears.

Specifically, the lithium secondary batteries of the examples and comparative examples were CC/CV charged (1C constant current, 4.6V, and 0.05C cut-off), and then the exothermic peak onset temperature was measured from the cathode active material layer by DSC analysis.

### (3) Evaluation of High-Temperature Storage Characteristics at 60° C.

The lithium secondary batteries of the examples and comparative examples were CC-CV charged (1C constant current, 4.6V) at room temperature, and then stored in air at 60° C. for 16 weeks using a sealed thermostatic device. After the high-temperature storage, the batteries were CC discharged at 0.5C rate (2.7V cut-off), and then the discharge capacity was measured (discharge capacity after high-temperature storage). The capacity retention rate was calculated by expressing the discharge capacity after high-temperature storage as a percentage of the capacity measured before high-temperature storage (initial capacity).

The analysis results according to Example 1 are shown in Table 2 below.

TABLE 2

| | | | | | | High- |
|---|---|---|---|---|---|---|
| | | | | | | temperature |
| | | | | | DSC | storage |
| | | | | | exothermic | capacity |
| | | | | | peak | retention |
| | | Measurement | Measurement | Measurement | onset | rate |
| Example 1 | Line-scan EDS | point #1 | point #2 | point #3 | temperature | (60° C.) |
| Major axis length (L) (μm) | | 11.1 | 10.8 | 6.1 | 252° C. | 92% |
| First surface | Integrated Mn | 1.613 | 1.544 | 1.524 | | |
| portion (0~0.5 | peak intensity | | | | | |
| μm) | | | | | | |
| Second surface | Integrated Mn | 2.278 | 1.788 | 1.835 | | |
| portion [(L − 0.5 | peak intensity | | | | | |
| μm)~L] | | | | | | |
| Surface portion | First surface | 3.891 | 3.332 | 3.359 | | |
| (0.5 μm depth from | portion + | | | | | |
| both ends) | Second surface | | | | | |
| | portion | | | | | |
| Central portion | Integrated Mn | 2.857 | 3.106 | 3.092 | | |
| [(Center − 0.5 μm)~(Center + | peak intensity | | | | | |
| 0.5 μm)] | | | | | | |
| Surface portion-to-central | | 136% | 107% | 109% | | |
| portion Mn content ratio (%) | | | | | | |
| First surface | Integrated Ni | 1.037 | 0.524 | 1.047 | | |
| portion (0~0.5 | peak intensity | | | | | |
| μm) | | | | | | |
| Second surface | Integrated Ni | 0.862 | 0.561 | 0.834 | | |
| portion [(L − 0.5 | peak intensity | | | | | |
| μm)~L] | | | | | | |
| Surface portion | First surface | 1.899 | 1.085 | 1.881 | | |
| (0.5 μm depth from | portion + | | | | | |
| both ends) | Second surface | | | | | |
| | portion | | | | | |
| Central portion | Integrated Ni | 2.659 | 1.823 | 2.136 | | |
| [(Center − 0.5 μm)~(Center + | peak intensity | | | | | |
| 0.5 μm)] | | | | | | |

| | | | |
|---|---|---|---|
| Surface portion-to-central | 71% | 60% | 88% |
| portion Ni content ratio (%) | | | |

The analysis results according to Example 2 are shown in Table 3 below.

TABLE 3

| | | | | | | High- |
|---|---|---|---|---|---|---|
| | | | | | | temperature |
| | | | | | DSC | storage |
| | | | | | exothermic | capacity |
| | | | | | peak | retention |
| | | Measurement | Measurement | Measurement | onset | rate |
| Example 2 | Line-scan EDS | point #1 | point #2 | point #3 | temperature | (60° C.) |
| Major axis length (L) (μm) | | 8.3 | 7.4 | 7.9 | 258° C. | 91% |
| First surface | Integrated Mn | 2.113 | 2.323 | 2.278 | | |
| portion (0~0.5 | peak intensity | | | | | |
| μm) | | | | | | |
| Second surface | Integrated Mn | 2.756 | 2.751 | 2.633 | | |
| portion [(L − 0.5 | peak intensity | | | | | |
| μm)~L] | | | | | | |
| Surface portion | First surface | 4.869 | 5.074 | 4.911 | | |
| (0.5 μm depth from | portion + | | | | | |
| both ends) | Second surface | | | | | |
| | portion | | | | | |
| Central portion | Integrated Mn | 2.531 | 2.703 | 2.585 | | |
| [(Center − 0.5 μm)~(Center + | peak intensity | | | | | |
| 0.5 μm)] | | | | | | |
| Surface portion-to-central | | 192% | 188% | 190% | | |
| portion Mn content ratio (%) | | | | | | |
| First surface | Integrated Ni | 0.714 | 0.516 | 0.854 | | |
| portion (0~0.5 | peak intensity | | | | | |
| μm) | | | | | | |
| Second surface | Integrated Ni | 0.883 | 0.546 | 0.672 | | |
| portion [(L − 0.5 | peak intensity | | | | | |
| μm)~L] | | | | | | |
| Surface portion | First surface | 1.597 | 1.062 | 1.526 | | |
| (0.5 μm depth from | portion + | | | | | |
| both ends) | Second surface | | | | | |
| | portion | | | | | |
| Central portion | Integrated Ni | 3.123 | 1.831 | 2.834 | | |
| [(Center − 0.5 μm)~(Center + | peak intensity | | | | | |
| 0.5 μm)] | | | | | | |

| | | | |
|---|---|---|---|
| Surface portion-to-central | 51% | 58% | 54% |
| portion Ni content ratio (%) | | | |

The metal content and DSC analysis results according to Comparative Example 1 are shown in Table 4 below.

TABLE 4

| | | | | | | High- |
|---|---|---|---|---|---|---|
| | | | | | | temperature |
| | | | | | DSC | storage |
| | | | | | exothermic | capacity |
| | | | | | peak | retention |
| Comparative | | Measurement | Measurement | Measurement | onset | rate |
| Example 1 | Line-scan EDS | point #1 | point #2 | point #3 | temperature | (60° C.) |
| Major axis length (L) (μm) | | 7.0 | 7.2 | 7.9 | 242° C. | 47% |
| First surface | Integrated Mn | 1.298 | 1.026 | 0.898 | | |
| portion (0~0.5 | peak intensity | | | | | |
| μm) | | | | | | |
| Second surface | Integrated Mn | 1.208 | 1.177 | 1.013 | | |
| portion [(L − 0.5 | peak intensity | | | | | |
| μm)~L] | | | | | | |
| Surface portion | First surface | 2.506 | 2.203 | 1.911 | | |
| (0.5 μm depth | portion + Second | | | | | |
| from both ends) | surface portion | | | | | |
| Central portion | Integrated Mn | 2.210 | 2.344 | 2.331 | | |
| [(Center − 0.5 μm)~(Center + | peak intensity | | | | | |
| 0.5 μm)] | | | | | | |
| Surface portion-to-central | | 113% | 94% | 82% | | |
| portion Mn content ratio (%) | | | | | | |
| First surface | Integrated Ni | 0.359 | 0.351 | 0.478 | | |
| portion (0~0.5 | peak intensity | | | | | |
| μm) | | | | | | |
| Second surface | Integrated Ni | 0.342 | 0.360 | 0.325 | | |
| portion [(L − 0.5 | peak intensity | | | | | |
| μm)~L] | | | | | | |
| Surface portion | First surface | 0.701 | 0.711 | 0.803 | | |
| (0.5 μm depth | portion + Second | | | | | |
| from both ends) | surface portion | | | | | |
| Central portion | Integrated Ni | 0.221 | 0.332 | 0.927 | | |
| [(Center − 0.5 μm)~(Center + | peak intensity | | | | | |
| 0.5 μm)] | | | | | | |

| | | | |
|---|---|---|---|
| Surface portion-to-central | 317% | 214% | 87% |
| portion Ni content ratio (%) | | | |

The metal content and DSC analysis results according to Comparative Example 2 are shown in Table 5 below.

TABLE 5

| | | | | | | High- |
|---|---|---|---|---|---|---|
| | | | | | | temperature |
| | | | | | DSC | storage |
| | | | | | exothermic | capacity |
| | | | | | peak | retention |
| Comparative | | Measurement | Measurement | Measurement | onset | rate |
| Example 2 | Line-scan EDS | point #1 | point #2 | point #3 | temperature | (60° C.) |
| Major axis length (L) (μm) | | 3 | 2.6 | 3.4 | 244° C. | 61% |
| First surface | Integrated Mn | 2.446 | 2.167 | 2.080 | | |
| portion (0~0.5 | peak intensity | | | | | |
| μm) | | | | | | |
| Second surface | Integrated Mn | 2.198 | 2.192 | 2.404 | | |
| portion [(L − 0.5 | peak intensity | | | | | |
| μm)~L] | | | | | | |
| Surface portion | First surface | 4.644 | 4.359 | 4.484 | | |
| (0.5 μm depth | portion + Second | | | | | |
| from both ends) | surface portion | | | | | |
| Central portion | Integrated Mn | 5.051 | 4.184 | 5.040 | | |
| [(Center − 0.5 μm)~(Center + | peak intensity | | | | | |
| 0.5 μm)] | | | | | | |
| Surface portion-to-central | | 92% | 104% | 89% | | |
| portion Mn content ratio (%) | | | | | | |
| First surface | Integrated Ni | 1.405 | 1.116 | 1.302 | | |
| portion (0~0.5 | peak intensity | | | | | |
| μm) | | | | | | |
| Second surface | Integrated Ni | 1.190 | 1.616 | 1.573 | | |
| portion [(L − 0.5 | peak intensity | | | | | |
| μm)~L] | | | | | | |
| Surface portion | First surface | 2.595 | 2.732 | 2.875 | | |
| (0.5 μm depth | portion + Second | | | | | |
| from both ends) | surface portion | | | | | |
| Central portion | Integrated Ni | 2.323 | 2.716 | 1.703 | | |
| [(Center − 0.5 μm)~(Center + | peak intensity | | | | | |
| 0.5 μm)] | | | | | | |

| | | | |
|---|---|---|---|
| Surface portion-to-central | 112% | 101% | 169% |
| portion Ni content ratio (%) | | | |

The metal content and DSC analysis results according to Comparative Example 3 are shown in Table 6 below.

TABLE 6

| | | | | | | High- |
|---|---|---|---|---|---|---|
| | | | | | | temperature |
| | | | | | DSC | storage |
| | | | | | exothermic | capacity |
| | | | | | peak | retention |
| Comparative | | Measurement | Measurement | Measurement | onset | rate |
| Example 3 | Line-scan EDS | point #1 | point #2 | point #3 | temperature | (60° C.) |
| Major axis length (L) (μm) | | 2.93 | 2.3 | 3.0 | 239° C. | 35% |
| First surface | Integrated Mn | 2.668 | 2.592 | 2.701 | | |
| portion (0~0.5 | peak intensity | | | | | |
| μm) | | | | | | |
| Second surface | Integrated Mn | 2.875 | 2.677 | 2.856 | | |
| portion [(L − 0.5 | peak intensity | | | | | |
| μm)~L] | | | | | | |
| Surface portion | First surface | 5.543 | 5.269 | 5.557 | | |
| (0.5 μm depth | portion + Second | | | | | |
| from both ends) | surface portion | | | | | |
| Central portion | Integrated Mn | 5.950 | 5.688 | 5.591 | | |
| [(Center − 0.5 μm)~(Center + | peak intensity | | | | | |
| 0.5 μm)] | | | | | | |
| Surface portion-to-central portion | | 93% | 93% | 99% | | |
| Mn content ratio (%) | | | | | | |
| First surface | Integrated Ni | 1.036 | 0.989 | 1.020 | | |
| portion (0~0.5 | peak intensity | | | | | |
| μm) | | | | | | |
| Second surface | Integrated Ni | 1.002 | 0.883 | 0.808 | | |
| portion [(L − 0.5 | peak intensity | | | | | |
| μm)~L] | | | | | | |
| Surface portion | First surface | 2.038 | 1.872 | 1.828 | | |
| (0.5 μm depth | portion + Second | | | | | |
| from both ends) | surface portion | | | | | |
| Central portion | Integrated Ni | 1.526 | 1.933 | 1.535 | | |
| [(Center − 0.5 μm)~(Center + | peak intensity | | | | | |
| 0.5 μm)] | | | | | | |

| | | | |
|---|---|---|---|
| Surface portion-to-central portion | 134% | 97% | 119% |
| Ni content ratio (%) | | | |

The metal content and DSC analysis results according to Comparative Example 4 are shown in Table 7 below.

TABLE 7

| | | | | | | High- |
|---|---|---|---|---|---|---|
| | | | | | | temperature |
| | | | | | DSC | storage |
| | | | | | exothermic | capacity |
| | | | | | peak | retention |
| Comparative | | Measurement | Measurement | Measurement | onset | rate |
| Example 4 | Line-scan EDS | point #1 | point #2 | point #3 | temperature | (60° C.) |
| Major axis length (L) (μm) | | 7.7 | 8.35 | 5.6 | 247° C. | 52% |
| First surface | Integrated Mn | 1.930 | 1.850 | 1.819 | | |
| portion (0~0.5 | peak intensity | | | | | |
| μm) | | | | | | |
| Second surface | Integrated Mn | 1.716 | 2.372 | 1.833 | | |
| portion [(L − 0.5 | peak intensity | | | | | |
| μm)~L] | | | | | | |
| Surface portion | First surface | 3.646 | 4.222 | 3.652 | | |
| (0.5 μm depth | portion + | | | | | |
| from both ends) | Second surface | | | | | |
| | portion | | | | | |
| Central portion | Integrated Mn | 3.965 | 4.110 | 3.804 | | |
| [(Center − 0.5 μm)~(Center + | peak intensity | | | | | |
| 0.5 μm)] | | | | | | |
| Surface portion-to-central | | 92% | 103% | 96% | | |
| portion Mn content ratio (%) | | | | | | |
| First surface | Integrated Ni | 0.912 | 0.736 | 0.646 | | |
| portion (0~0.5 | peak intensity | | | | | |
| μm) | | | | | | |
| Second surface | Integrated Ni | 0.745 | 0.943 | 0.747 | | |
| portion [(L − 0.5 | peak intensity | | | | | |
| μm)~L] | | | | | | |
| Surface portion | First surface | 1.657 | 1.679 | 1.393 | | |
| (0.5 μm depth | portion + | | | | | |
| from both ends) | Second surface | | | | | |
| | portion | | | | | |
| Central portion | Integrated Ni | 0.891 | 1.306 | 1.418 | | |
| [(Center − 0.5 μm)~(Center + | peak intensity | | | | | |
| 0.5 μm)] | | | | | | |

| | | | |
|---|---|---|---|
| Surface portion-to-central | 186% | 129% | 98% |
| portion Ni content ratio (%) | | | |

Referring to Tables 2 to 7 above, improved thermal stability was achieved after high-voltage charging of the lithium secondary batteries using the over-lithiated oxide particles of the examples in which the concentration gradients of manganese and nickel were formed, as described above. In addition, a significantly increased capacity retention rate was achieved after high-voltage charging and high-temperature storage compared with the Comparative Examples.

In Example 2, as the manganese content in the surface portion increased rapidly compared to Example 1, the thermal stability was relatively improved. However, the rate characteristics of the secondary battery may be degraded due to the high manganese content in the surface.

1. A cathode for a lithium secondary battery comprising:
a cathode current collector; and
a cathode active material layer formed on the cathode current collector and comprising over-lithiated oxide particles containing nickel and manganese, wherein a molar ratio of lithium to total metal elements is greater than 1,
wherein a manganese content in a surface portion of the over-lithiated oxide particles is greater than a manganese content at a central portion thereof, and
a nickel content in the central portion of the over-lithiated oxide particles is greater than a nickel content in the surface portion thereof.

2. The cathode for a lithium secondary battery according to claim 1, wherein a ratio of the manganese content in the surface portion to the manganese content in the central portion is in a range of 105% to 200%.

3. The cathode for a lithium secondary battery according to claim 1, wherein the ratio of the manganese content in the surface portion to the manganese content in the central portion is in a range of 105% to 150%.

4. The cathode for a lithium secondary battery according to claim 1, wherein a ratio of the nickel content in the surface portion to the nickel content in the central portion is in a range of 50% to 95%.

5. The cathode for a lithium secondary battery according to claim 1, wherein the ratio of the nickel content in the surface portion to the nickel content in the central portion is in a range of 60% to 95%.

6. The cathode for a lithium secondary battery according to claim 1, wherein the central portion and the surface portion of the over-lithiated oxide particles have different lithium contents.

7. The cathode for a lithium secondary battery according to claim 6, wherein the central portion has a relatively lower lithium content and the surface portion has a relatively higher lithium content.

8. The cathode for a lithium secondary battery according to claim 1, wherein the over-lithiated oxide particles exhibit a concentration gradient between the central portion and the surface portion.

9. The cathode for a lithium secondary battery according to claim 1, wherein the over-lithiated oxide particles have a chemical structure represented by Formula 1 below:
Liₐ[MₓNi_{y}Mn_{z}]O_{b} [Formula 1]
(in Formula 1, M includes at least one of Co, Na, Ca, Y, Hf, Ta, B, Si, Ba, Ra, Mg, V, Ti, Al, Fe, Ru, Zr, W, Sn, Nb, Mo, Cu, Zn, Cr, Ga and Bi, and x, y, z, a and b satisfy 0≤x≤0.9, 0<y≤0.9, 0.1≤z≤0.9, 1.8≤a+x+y+z≤2.2, 1.05≤a/(x+y+z)≤1.95, 1.8≤b≤2.2).

10. The cathode for a lithium secondary battery according to claim 9, wherein a mole fraction of manganese to the total elements excluding lithium and oxygen in the over-lithiated oxide particles is 0.5 to 0.75.

11. The cathode for a lithium secondary battery according to claim 1, wherein the central portion is a region extending radially outward from the center of the over-lithiated oxide particle within a range of 0.5 μm, and
the surface portion is a region extending inward from the outermost surface of the over-lithiated oxide particle toward the center within a depth or thickness of 0.5 μm.

12. The cathode for a lithium secondary battery according to claim 1, wherein the contents of manganese and nickel are determined based on integrated peak intensity values of manganese and nickel obtained by a line-scan EDS analysis performed along a straight line passing through the center on the cross-section of the over-lithiated oxide particle exposed to the cross-section of the cathode active material layer, from one end to the other end of the particle.

13. The cathode for a lithium secondary battery according to claim 1, wherein the over-lithiated oxide particles comprise at least one of a Li₂MnO₃ domain and a domain derived from the Li₂MnO₃ domain.

14. The cathode for a lithium secondary battery according to claim 13, wherein the domain derived from the Li₂MnO₃ domain comprises at least one selected from the group consisting of MnO₂, Mn₂O₄, LiMnO₂, LiMn₂O₄ and Li₂Mn₂O₄.

15. A lithium secondary battery comprising:
the cathode for a lithium secondary battery according to claim 1; and
an anode disposed opposite to the cathode.
